(19) United States
(12) Patent Application Publication
(10) Pub. No.: US 2003/0041314 A1
(43) Pub. Date: Feb. 27, 2003

(54) Call flow method and system using visual programming

(75) Inventors: Penny J. Heeren, Mount Vernon, IA (US); Aleksey V. Solatov, Cedar Rapids, IA (US)

Correspondence Address: BRINKS HOFER GILSON & LIONE, P.O. Box 10395, Chicago, IL, 60610, US

(73) Assignee: APAC Customers Services, Inc.

(21) Appl. No.: 09/930,504

(22) Filed: Aug. 14, 2001

(51) Int. Cl. G06F 9/44

(52) U.S. Cl. 717/109; 705/10

(57) ABSTRACT

Call flow script is generated for telemarketing or customer service. A template and associated tools or stencils usable within visual programming software are used to generate scripts for telemarketing or customer service companies. Call flow charts or scripts are created using the template and stencils with the visual programming software. A conversion program generates and compiles presentation or linking display information from the visually programmed data. By providing automatic conversion, marketing or service changes to the call flow chart or associated decision tree are easily implemented. Automatic conversion with a processor also allows individuals unfamiliar with detailed programming to generate or change call flows and associated information used by the operators. Visual programming allows a company to easily confirm desired script and visualize the call flow process.

### BACKGROUND

This invention relates to telephone based or computer network based scripted communication. In particular, the invention relates to the generation of call flow information for customer service or marketing.

Call centers are staffed with a plurality of operators. The operators either call potential customers for marketing or receive calls from customers. The operators provide information and request information based on a script.

A call flow chart provides text information to be read by the operator as well as associated linking information to further text based on a customer's response. The call flow chart is designed to solicit business or provide the best services possible to a customer.

To design the call flow chart, the chart may be drawn by hand or programmed in a computer. For example, Visio software from Microsoft Corporation is used to generate a visual representation of the call flow chart. The text and associated links within the call flow chart are edited or changed to perfect the operator communication.

After the desired call flow chart is developed, programmers generate software code for providing the script to all of the various operators. Using the call flow chart, computer programmers spend hours programming a presentation program, such as a program using extensible markup language (XML) to display the appropriate call flow chart information. Customer service and marketing organizations may desire rapid implementation of a call flow chart, requiring additional computer programmers and overtime work.

### BRIEF SUMMARY

The present invention is defined by the following claims, and nothing in this section should be taken as a limitation on those claims. By way of introduction, the preferred embodiments described below include a method and system for generating a call flow script. A conversion program automatically converts visually programmed information to a plurality of displayed images and associating links. A processor automatically performs the conversion, resulting in reduced coding or programming for generating a presentation usable by operators.

A template and associated tools or stencils usable within visual programming software are used to generate scripts for telemarketing or customer service companies. Call flow charts or scripts are created using the template and stencils with the visual programming software. A conversion program generates and compiles presentation or linking display information from the visually programmed data. By providing automatic conversion, marketing or service changes to the call flow chart or associated decision tree are easily implemented. Automatic conversion with a processor also allows individuals unfamiliar with detailed programming to generate or change call flows and associated information used by the operators. Visual programming allows a company to easily confirm desired script and visualize the call flow process.

In a first aspect, a method for generating a call flow script is provided. Call flow information is visually programmed. A processor using a conversion program converts the visually programmed call flow information to code for a presentation program.

In a second aspect, another method for generating a call flow script is provided. A processor converts first computer data representing script information in a call flow chart to script computer data formatted for linking display software. The processor also converts second computer data representing flow in the call flow chart to linking computer data formatted for the linking display software. The script computer data is associated with the linking computer data.

In a third aspect, a system for generating a call flow script is provided. A first computer is used for visually programming call flow information and is operable to convert the visually programmed call flow information to code for linking display program in response to a conversion program. A plurality of computers are provided for displaying a plurality of script panels. The script panels are linked as a function of the call flow information. The script panels are generated with the linking display program.

Further aspects and advantages of the invention are discussed below in conjunction with the preferred embodiments.

### BRIEF DESCRIPTION OF SEVERAL VIEWS OF THE DRAWINGS

FIG. 1 is a block diagram of one embodiment of a system for generating and using a call flow script.

FIG. 2 is a block diagram representing one embodiment of a method for generating a call flow script.

FIG. 3 is a graphical representation of one embodiment of a call flow chart generated with visual programming.

FIG. 4 is a flow chart representing one embodiment for creating or adding text or linking information to a call flow chart.

FIG. 5 is a flow chart representing one embodiment of a method for generating rules for a call flow chart.

FIG. 6 is a block diagram representing various components used for converting visually programmed data to presentation program data in one embodiment.

FIG. 7 is a graphical representation of one embodiment of an image provided by a presentation program.

FIG. 8 is a flow diagram of one embodiment of a process for generating visually programmed information from presentation program information.

### DETAILED DESCRIPTION OF THE PREFERRED EMBODIMENTS

Call flow information is visually programmed. A processor automatically converts the visually programmed information into data formatted for use by a presentation program. Operators then use the presentation program to provide information and request information. The conversation by the operators is scripted according to the call flow information and communicated to the operator using the presentation program.

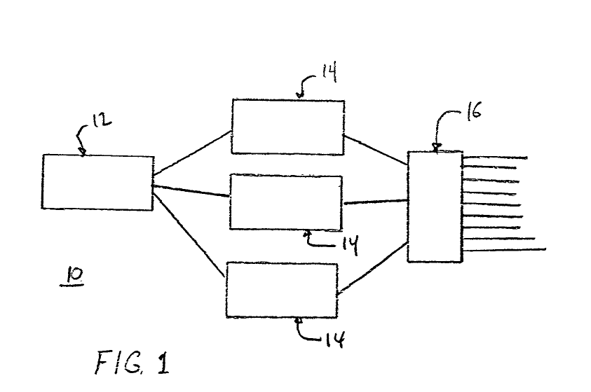

FIG. 1 shows a system for generating and using a call flow script in one embodiment. For example, a call center 10 includes a computer and associated processor 12, a plurality of customer service computers 14 and a telephone system 16. The call center 10 is used for telemarketing or customer service. In alternative embodiments, a computer network marketing or customer service center is provided. E-mails or real time messages are provided over a computer network and communications scripted according to the call flow.

The computer 12 includes one or more processors operating pursuant to various programs. The computer 12 comprises a laptop computer, desktop computer, a specialized or dedicated computer, or other processor based device for visual programming and converting visually programmed data to data formatted for a presentation program. The computer 12 is located remotely from the remainder of the call center 10 or at the call center 10. In alternative embodiments, the computer 12 comprises a plurality of computers, such as one computer for visual programming and a second computer for converting the visually programmed data to data for a presentation program. In yet other alternative embodiments, the computer 12 comprises a mainframe or network of computers.

The customer service computers 14 comprise workstations, laptops, desktops, terminals, other computers of combinations thereof for generating displays and receiving input information. The customer service computers 14 operate pursuant to a presentation program to generate call flow information and receive associated input. For example, text comprising one or more queries and associated possible responses are provided in an order responsive to an operator's input. The customer service computers 14 directly link to the computer 12 or include information from the computer 12 provided on a diskette, compact disk or other storage medium without a direct link. As a result, the call flow script information presented on the customer service computers 14 is updated in real time as changes are made on the computer 12 through visual programming or altered in non-real time, such as associated with a disk transfer.

In one embodiment, the computer 12 is operated by a customer service or telemarketing service company, and the customer service computers 14 are operated by the same or a different company. For example, one company provides the data used by the presentation program based on a call flow analysis, and another company purchases the data. The company purchasing the data then uses the data on their customer service computers 14 for telemarketing or customer help.

The telephone system 16 comprises digital and/or analog circuits for routing one or more incoming telephone connections to a respective one or more operators. Telephone connection information may also be routed to the associated customer service computers 14. In one embodiment, the telephone system 16 comprises a switch and associated programming. Calls are connected from an operator through the telephone system 16 to a customer or potential customer. Call status information is provided from the telephone system 16 to the customer service computer 14. In one embodiment, the presentation program provides call connection status information and one or more options associated with a particular connection. For example, conference calls, ending or hanging up a call, recording a call or other telephone connection options are provided to the operator as buttons or selections on the customer service computer 14. In alternative embodiments, the customer service computers 14 are separate from the telephones 16, and the operators control the call connections using other devices, such as a telephone.

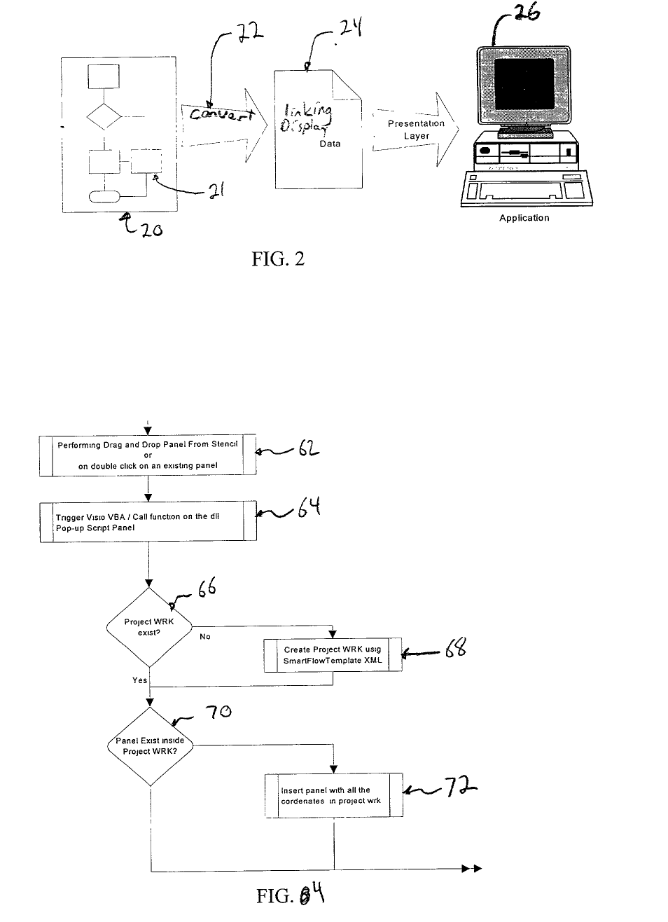

FIG. 2 is a block diagram showing one embodiment of the visual programming of a flow call script, a conversion of visually programmed data to presentation program data and application or use of the data. Block 20 represents a visual program. For example, block 20 represents Visio by Microsoft Corporation, but other visual programming software or tools may be used. A call flow chart 21 representing scripted call flow is generated by a processor using the visual programming software. For example, a template and associated stencils are provided for use with the visual program. A template comprises a file structure, and a stencil comprises one or more shapes or objects associated with generating a call flow chart. Using the template and stencil with the visual programming, the call flow is diagramed, including scripting text, assigning variables or other data capture information, navigation and associated links between scripted information and logical rule sets. In alternative embodiments, one or both of the template and stencil are not provided or additional files or programs are used for interaction between the visual programming software and the user.

Visual programming allows a user to generate a call flow chart or to script call flow. In one embodiment, a plurality of objects or shapes are provided, such as by the stencil program. An object is selected and added to a call flow chart. Properties are associated with the objects or shapes to indicate a process, text, rule, query, control function, other call flow activity or combinations thereof. Using a user interface, the user selects one or more shapes and generates or scripts the call flow chart by inserting data.

In one embodiment, an object is provided for each panel or displayed image. The user generates the call flow script by inserting data within the panel object and then linking the panel objects together as a function of logic or rules. The panel object is thus inserted within the call flow chart.

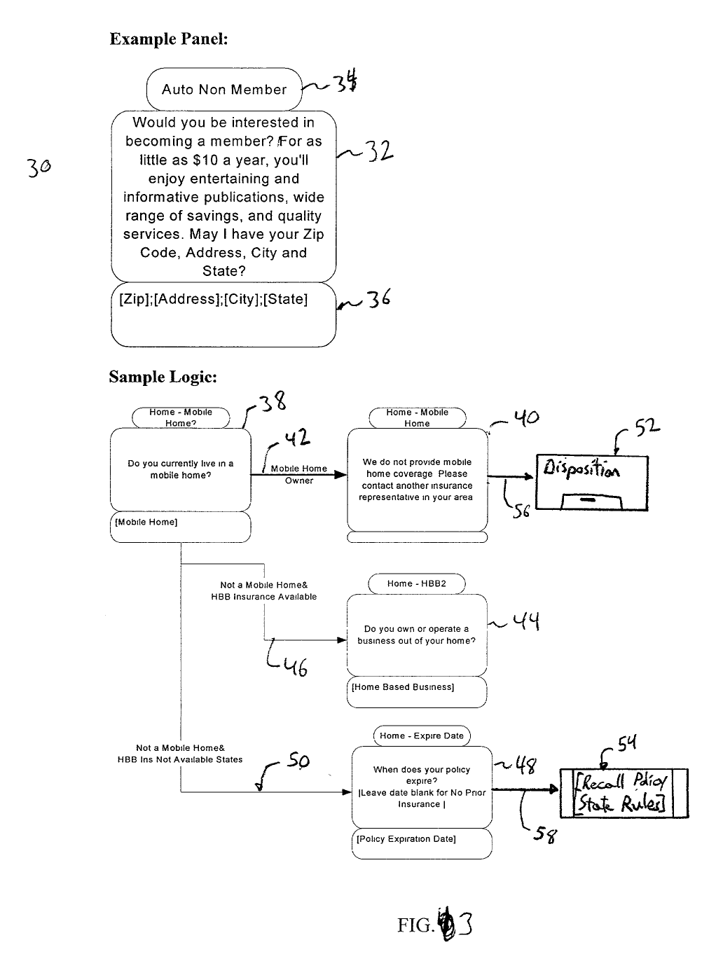

FIG. 3 shows a represented panel object 30 and associated call flow chart with a plurality of panel objects and associated links. The panel object 30 is provided without any text. As shown in FIG. 3, text is inserted within the panel object 30. Other objects include a process, telephone control, dynamic connection, insert data, business rule, or other object. Fewer or additional objects may be used.

The process object is used to navigate to other call flow charts or sub-call flow charts (e.g. object based programming techniques), or to provide additional services or processes, such as telecommunications control or database searches. For example, telephone system processes conference calling, caller identification or other controls may be performed as part of a process object. The process objects are programmed to interact with other systems, such as the telephone system 16. Other external interactions may be programmed into a process object, such as docketing a call back time and phone number.

Another separate object may be associated with ending a call or communication connection to terminate a call. The “end call” object is associated with internal and/or external processes. For example, obtained data is saved on a database in response to an end call object. A disposition sub-call flow or data field may be activated or linked to in response to an end call object.

A dynamic connector or link for indicating navigation between panel objects or other objects may be provided. The dynamic connector provides flow information.

An insert data object may be provided for pulling information or using information from other programs or data sources. For example, a data base of previous calls or customer accounts is searched and pulled.

Yet another object is a business rule object for limiting call flow. For example, a business rule is applied to a particular dynamic connectors or panel objects indicating a restricted class, such as people from Illinois, allowed to navigate along that section of the call flow chart.

After an object is selected, various information may be associated or input to the object. For example, a panel object comprises a query or text section 32, a header section 34 and a variable section 36. Text representing the title or header for a displayed image is entered into the title section 34. Queries soliciting a response or other script or text is inserted into the text section 32. Variables to be obtained from a customer or a potential customer are entered into the variable section 36. For example, a yes or no response to owning a mobile home as shown with the object 38, zip code address city state or other variable information may be used. Variables and any possible responses are defined as properties of each data object. The definition of the property is added directly to the XML document, added in a dialog box in the visual program (e.g. added using Visio) or as part of another visual programming tool. Properties include the type of variable (e.g. text box, phone number text box, list box, check box, option group or others), the type of data permitted (e.g. numbers only, text only, a certain number of alpha and/or numbers in certain combinations or others), whether or not the response or data is required, and others. In one embodiment, source structured query language (SQL) is associated with one or more variables and obtains data from other databases or previously provided in a same database for populating one or more responses. Save SQL may store data captured during a call into one or more databases.

In one embodiment, alternative information is provided. For example, text in different languages are provided. The text sections are replaceable or selectable in response to an input. A user sets a flag or language option or inputs a language, and the system automatically provides text or scripted call flow associated with the selected language. In other embodiments, other objects, processes, links, text or characteristics of the call flow are response to a user selection or input, such as language, function, access level or other parameter.

After two or more objects, such as panel objects, process objects or an end call object are generated, the objects are linked by one or more dynamic connectors 42, 46, 50. For example, four panel objects 38, 40, 44 and 48 are linked by dynamic connectors 42, 46 and 50 to provide the logic for the call flow chart. Information associated with each dynamic connector 42, 46, 50 is defined. For example, data corresponding to one or more variables indicates navigation or connection along a dynamic connector. In the example shown in FIG. 3, an input to the variable data of the panel object 38 that a mobile home is owned indicates navigation along the dynamic connector 42 to the object panel 40. A response that a mobile home is not owned is linked over one of the dynamic connectors 46 or 50 as a function of a previously indicated state of residence.

Other dynamic connectors indicate direct or non-conditional links, such as dynamic connectors 56 and 58. The dynamic connector 56 connects the panel object 40 to an end call object 52. The operator may be solicited to input additional information regarding the disposition of a phone call in response to an end call object. In alternative embodiments, further links and associated panels for obtaining the disposition information are provided or a process object is provided to link to a sub-call flow chart. As yet another example of a direct dynamic connection, the dynamic connector 58 connects the panel object 48 to a process object 54. The process object 54 is associated with a particular process or computer software sub-routine. For example, state rules for particular types of insurance policies are recalled from a database and provided to the operator in response to navigation to the process object 54. As yet another example, all or a subset of panel objects are directly linked to associated rebuttal objects. In response to selection of a rebuttal, the text in the rebuttal object associated with text in the panel object is displayed.

As shown in FIG. 3, a plurality of different objects and associated link or dynamic connectors may be provided. Objects having different shapes or indications may be used. In one embodiment, a visual programming user interface provides a template of available stencil objects. A visual programmer clicks and drags objects to generate the call flow chart.

In addition to visually programming for particular scripted panels, processes or ending a call, global level visual programming may be provided. For example, one or more navigation buttons to be provided on each image displayed are defined on a global level. In one embodiment, the template file of the visual programming software is associated with an options menu for selecting various buttons. For example, “starting over”, “back”, “directory”, “next”, “exit”, and “rebuttal” buttons are provided. Additional or fewer buttons may be defined. Further information such as the presentation of the time and date may be defined globally. In one embodiment, the global file information is programmed by a programmer for the presentation program and added to the call flow chart created as discussed herein.

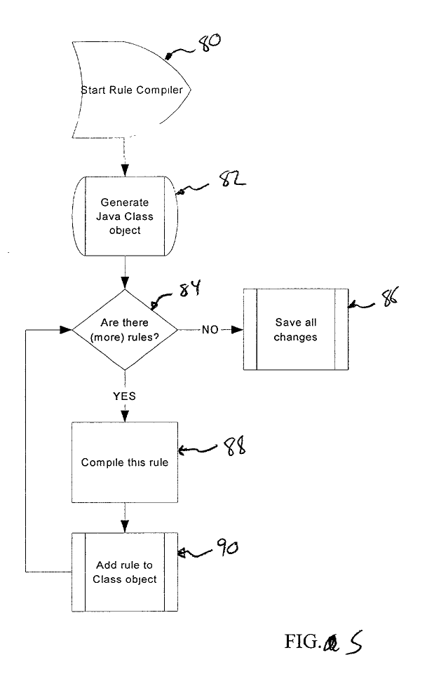

FIG. 4 is a flow chart representing the creation or addition of a panel or image within a call flow script. In act 62, a panel object is selected, dragged or dropped from the stencil into the template. To edit a panel object, the panel object is double clicked or otherwise selected for editing. In act 64, a Visual Basic for Applications macro is triggered or selected using a data link library. A function associated with the presentation program is run, providing a pop-up window, form or graphic for prompting or allowing data entry of text or other information. An associated pop-up or highlighted script panel object is displayed for entry of text or other information. In response to act 64, associated data elements that have been defined and are available for use, such as data associated with the presentation program corresponding to an already converted call flow chart, are listed and are available for insertion or selection. Defined business rules are likewise available and listed. The template also includes icons for creating additional business rules or data elements. In act 66, the visual programming software checks for a call flow work file. If a call flow work file does not exist, one is created using the template in act 68. In act 70, the selected panel object is compared to the call flow chart and the working file. If the panel exists based on the tile, text or variables, an indication is provided. If the panel does not exist, the panel associated with the selected panel object is inserted within the working file in act 72. In act 72, any links or other logic associated with the panel object are selected and inserted.

In FIG. 4, the conversion between the visual programming and the presentation program occurs in real time as the visual programming is performed. In alternative embodiments, an entire call flow chart or a portion of a call flow chart may be generated prior to any conversion.

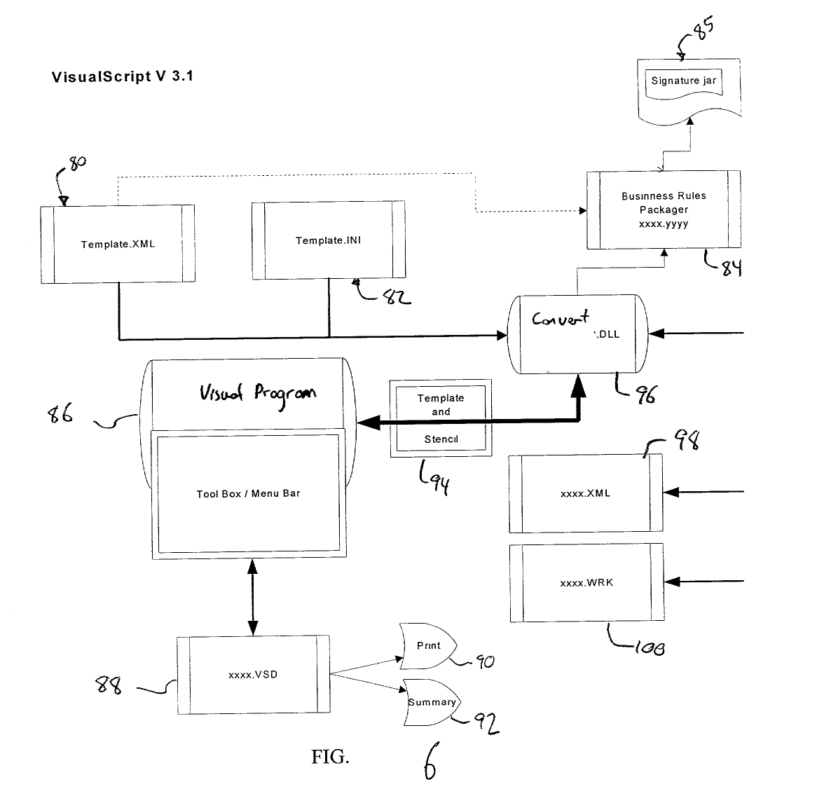

As discussed above, business rules may be used for a call flow chart. In one embodiment, Java script is used for defining rules, but other applications and associated formats may be used. FIG. 5 is a flow chart representing the process of enabling compilation of Java based business rules. In response to a selection on the template, the rule compiler is started in act 80. A Java class object is generated in act 82. The Java class object defines the business rule as a function of one or more variables obtained as part of the call flow script. In alternative embodiments, the business rule is defined as a textual rule regardless of any variables. In act 84, additional business rules may be generated and/or solicited. If no additional business rules are desired, all changes are saved in act 86. If additional rules are desired, the additional rule is compiled in act 88 and added to the Java class object in act 90. The process then returns to act 84. Other rule generation processes using other computer formats may be used.

In one embodiment, business rules are created at one company and included with a template or presentation program data to a telemarketing or customer services company. The rule compiler program may be distributed separately from the stencil and template.

Referring again to FIG. 2, the data from the visual program 20 is converted 22. The conversion is automatic or performed by a computer processor as opposed to a computer programmer programming the presentation. For example, the conversion occurs automatically in response to entry of information using visual programming software. Alternatively, a macro or conversion program is selected by a user. The designated file is then converted.

The visual programming data is converted to linking display data 24. The linking display data 24 is used by a presentation program of the presentation layer for generating a display on a computer 26. The linking display data 24 comprises XML data, hypertext markup language (HTML) data or other linking display code. Linking display code comprises data formatted for generating displays associated with one or more links to additional displays. In one embodiment, text files associated with a format for interactive voice response (IVR).

FIG. 6 shows the software environment for visually programming and automatically converting between visually programmed data and data formatted for a linking display program. The environment includes the template 80 formatted for linking display software. A template.ini file 82 is provided for giving the basic underlying structure of the file to be generated for each new applications coded with this system. Configurations for Microsoft Windows Operating Systems, Java enabled systems or other operating systems may be used. A business rules packager 84 as discussed for FIG. 5 is also provided. Previously compiled business rules are saved in a separate file 85. A working file 100 and any saved linking display code files 98 are also provided. The working file comprises a file in any of various formats including visual programming data formats or linking display or presentation program display formats. The visual programming software 86 and associated tool box or menu bar are responsive to the template and associated stencil 94 provided for the conversion. Visual programming data 88 interacts with the visual programming software 86. A particular visual programming file may be printed 90 or summarized 92 using the visual programming software 86. A conversion program 96 converts between visual programming data and linking display data. The conversion program 96 comprises a data or dynamic link library or other software for associating various of the visual programming objects with displayed and linked information. In one embodiment, the conversion program 96 comprises an executable program, such as an executable Java program.

The conversion program 96 identifies the various objects from the visually programmed data 88. Text and variables associated with panel objects are converted by copying to a display panel from an appropriate library of linking display or presentation program data. Likewise links and associated rules are identified from the visually programming data 88 and converted by linking to a library of associated links and rules within the linking display template 80 and business rules packager 84. Other objects associated with the visual program 86 are also converted.

After the visual programming objects are converted to presentation program or linking display attributes, the various attributes are associated. For example, links and rules associated with text and other information for display and navigation are configured. Any order may be used for converting particular types of objects or particular objects. For example, the conversion program 96 sequentially processes through visually programmed call flow chart. As another example, the conversion program 96 converts all the panel objects first, all the dynamic connection objects second and other objects last.

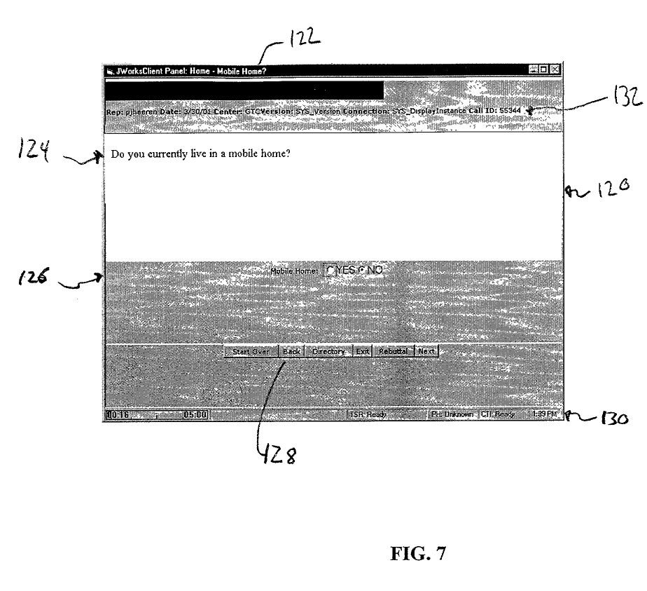

FIG. 7 shows a script panel 120 generated as an image by the linking display software. The script panel 120 is generated in response to the panel object 38 of FIG. 3. The text from the header section 34 is displayed as the title 122 of the window or image representing the script panel 120. The text from the query section 32 is displayed in a box 124 of the script panel 120. The variable and associated text from the variable section 36 is displayed in a section 126 below the box 124. The text and associated possible responses for the variable are defined when the variable field for the variable section 36 is created.

Other information on the script panel, including the navigation buttons 128, the current status information 130 and user and program information 132 are globally defined and provided for a plurality of script panels 120. Included within the navigation buttons 128 is a rebuttal button. The rebuttal button provides information associated with negative responses or help information associated with the text within a script panel 120. The rebuttal information may be programmed as part of a panel object or separately.

For example, XML code generated by the conversion program 96 from the templates for the script panel 120 is as follows:

<PANEL ID=“7729” NAME=“Home - Mobile Home?”
AGENT_INSTRUCTIONS=““WINDOW_STATE=””>

<VERBIAGE ID=“7730”><html ID=“7733”><P ID=“7734”><font

ID=“7735” COLOR=“blue” SIZE=“4”>Do you currently live in a mobile
home?</font></P></html></VERBIAGE>

<FORM ID=“7731”URL=““NEWWINDOW=”“POSTGETDATA=””

METHOD=““DATAITEM=“Mobile Home”> </FORM>

<NAVIGATION ID=“7732”>

<COMMAND ID=“7736” NAME=“Next” SERVICE””

DESCRIPTION=““DESTINATION=“Home - Foremost Insurance
Group”
RULES_ATTACHED=““HOTKEY=“n”>

<COMMAND ID=“7737” NAME=“Next” SERVICE=””

DESCRTPTION=““DESTNATION=“Home - HBB2”
RULES_ATTACHED=“Not a Mobile Home&amp;HBB Insurance
Available” HOTKEY=“n”> </COMMAND>

<COMMAND ID=“7738” NAME=“Next” SERVICE=““

DESCRIPTION =”” DESTINATION=“Home - Expire Date”
RULES_ATTACHED=“Not a Mobile Home&amp;HBB Ins Not
Available States” HOTKEY=“n”> </COMMAND>
</COMMAND>

</NAVIGATION>
</PANEL>

During use of the script panel 120, an operator reads the text from the box 124 to a customer or potential customer. The customer's response is entered by selecting one of the two possible options from the section 126 and clicking on the next button from the buttons 128. In response to clicking the next button or other input the linking display code links to the next script panel as a function of the selected response. The call flow script is provided to the operator to solicit business from the customer or provide services to the customer. The plurality of script panels 120 is provided as a function of the visually programmed call flow chart.

In alternative embodiments, different display formats may be used. For example, a non-windows based format may be used. In yet other alternative embodiments, additional information is provided, such as a highlighted display of the call flow chart. Any display and associated input configuration allowing an operator to read scripted material to a customer or potential customer and navigate through a scripted call flow may be used.

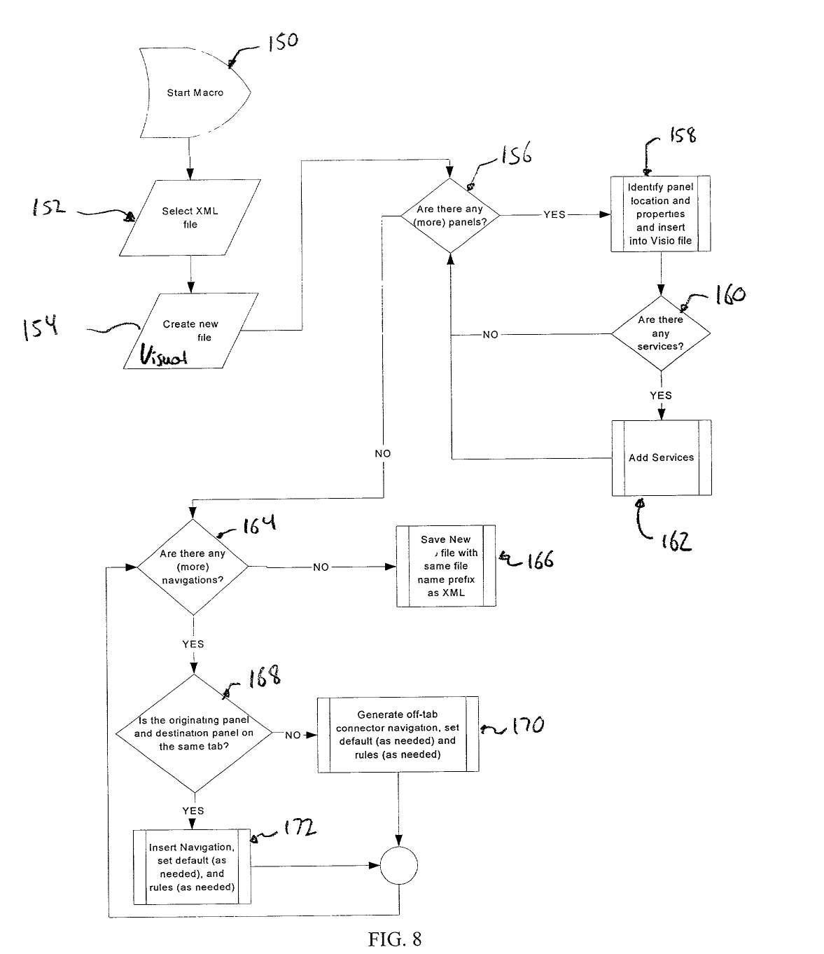

The conversion as discussed above converts from visual programmed data to data formatted for a presentation program. The conversion may also convert from presentation programmed data to data formatted for visual programming. For example, converting to visual programming data may allow changes, additions or deletions from a call flow script. FIG. 8 shows a method for converting from linking display data to visual programming data. A same or similar process may be used for converting from the visual programming data to the linking display data.

The conversion macro or conversion program is started in act 150. In act 152, the presentation program or linking display program file of data is selected. A new visual file is created in act 154. For example, a blank template associated with the conversion program is named and saved. In act 156, the conversion programs identifies a first script panel. For each script panel, the panel location within the call flow script and the properties, such as text, variables, rules or other properties associated with the script panel are identified. The script panels are then inserted into the visual file as panel objects. The script panel is also examined for any service calls in act 160. Service calls include retrieving data from a database, controlling operation of the phone (e.g. transfer a call, hang-up a call, initiating a conference call), navigating on a web page embedded within the application or other system function. In act 162 any additional services are added. After all script panels are identified and inserted as panel objects, the process examines the linking display data for navigations or linking logic in act 164. For each link, the tab or page structure associated with the connected script panels is examined in act 168. The tab structure represents different pages in a visual diagram, such as a Visio Diagram. Connecting multiple pages enables dividing complex call flows into smaller pieces that can be edited separately, but can also be called from other pages or tabs. Where various script panels are associated with tabs in a single window or display, appropriate dynamic link information and rules are selected in act 172. Where tab structure is not used, dynamic links, defaults and associated rules are set in act 170. Once all of the script panels and associated links are identified and converted to visual programming data, the visual programming data is saved. In one embodiment, the same name prefix is used for saving the visual programming data as is used for storing the linking display data.

In one embodiment, visual programming is used to generate or program an interactive voice response (IVR) system. The IVR system is programmed and documented for routing calls to individuals, groups or systems based on responses. A conversion program converts the visually programmed IVR call flow into a text or other format appropriate for the IVR system. The IVR system routes a call as a function of customer input and provides recorded voice output based on visual programming.

Other workflow processes or configurations may be programmed or configured using visual programming with software conversion to an appropriate system. IVR systems, call center systems and other non-call center systems can be configured.

While the invention has been described above by reference to various embodiments, it will be understood that many changes and modifications can be made without departing from the scope of the invention. For example, different types of visual programming and presentation program software may be used. Additional or fewer objects and associated attributes may be used.

It is therefore intended that the foregoing detailed description be understood as an illustration of the presently preferred embodiments of the invention, and not as a definition of the invention. It is only the following claims, including all equivalents, that are intended to define the scope of the invention.

What is claimed is:

1. A method for generating a call flow script, the method comprising:
(a) visually programming call flow information; and
(b) converting the visually programmed call flow information to code for a presentation program with a processor in response to a conversion program.

2. The method of claim 1 wherein (a) comprises generating a flow chart with software and the processor.

3. The method of claim 1 wherein (a) comprises:
(a1) inserting at least first, second and third text data; and
(a2) linking the first text data to both the second and third text data with first and second links.

4. The method of claim 3 wherein (a2) comprises associating query response information with the first and second links.

5. The method of claim 1 wherein (a) comprises selecting at least one call flow chart object.

6. The method of claim 5 wherein (a) comprises selecting the one call flow chart object comprises a telephone control option.

7. The method of claim 1 further comprising:
(c) adding a call flow query and associated link to the visually programmed call flow information.

8. The method of claim 1 further comprising:
(c) converting code for the presentation program to a visual call flow chart with the processor.

9. The method of claim 8 wherein (c) comprises:
(c1) identifying a plurality of queries; and
(c2) identifying at least one link associated with each of the plurality of queries.

10. The method of claim 1 wherein (b) comprises converting a flow chart into linking display code.

11. The method of claim 10 wherein (b) comprises converting the flow chart into one of XML and HTML code.

12. The method of claim 1 further comprising:
(c) displaying call flow script information in response to the code and the presentation program.

13. The method of claim 1 further comprising:
(c) loading a template and associated stencils formatted for use in (a).

14. The method of claim 1 wherein (b) comprises:
(b1) identifying script and links from the call flow information; and
(b2) coding the script and links in a format for the presentation program.

15. The method of claim 14 wherein (b1) comprises identifying variables and (b2) comprises coding the links as a function of possible values of the variables.

16. The method of claim 1 wherein (b) comprises converting in response to selection of a conversion macro provided with the visual programming.

17. The method of claim 1 wherein (b) comprises converting with an executable program.

18. A method for generating a call flow script, the method comprising:
(a) converting with a processor first computer data representing script in a call flow chart to script computer data formatted for linking display software;
(b) converting with the processor second computer data representing flow in a call flow chart to linking computer data formatted for the linking display software; and
(c) associating the script computer data with the linking computer data.

19. The method of claim 18 further comprising:
(d) generating the call flow chart with visual programming software on the processor.

20. The method of claim 19 wherein (d) comprises:
(d1) selecting at least one call flow chart object;
(d2) inserting text data associated with the call flow chart object; and
(a2) linking the call flow chart object with other objects.

21. The method of claim 18 wherein (a) and (b) comprise converting into data formatted as one of XML and HTML code.

22. The method of claim 18 further comprising:
(d) displaying the script in a plurality of images; and
(e) linking the plurality of images for (d) as a function of the flow.

23. The method of claim 19 further comprising:
(d) identifying the script and the flow of the call flow chart from data formatted for the visual programming software;
wherein the converting of (a) and (b) comprises automatically converting from data formatted for the visual programming software to data formatted for the linking display software.

24. The method of claim 23 wherein (a), (b) and (d) comprise converting in response to selection of a conversion macro provided with the visual programming.

25. A system for generating a call flow script, the system comprising:
a first computer for visually programming call flow information and for converting the visually programmed call flow information to code for a linking display program in response to a conversion program; and
a plurality of computers each for displaying a plurality of script panels linked as a function of the call flow information, the script panels generated with the linking display program.

26. The system of claim 25 wherein the plurality of computers comprises a plurality of customer service computers.

27. The system of claim 25 further comprising a telephone system wherein the plurality of computers are connected with the telephone system, at least one of the displays associated with changing a status of a telephone connection.

28. The system of claim 25 wherein the conversion program comprises an executable program.

29. The system of claim 25 wherein the linking display program comprises one of HTML and XML.
